(19) United States
(12) Patent Application Publication
(10) Pub. No.: US 2011/0315678 A1
(43) Pub. Date: Dec. 29, 2011

(54) MICROWAVE HEATING DEVICE

(76) Inventors: Shinichiroh Furuya, Tokyo (JP); Hirofumi Amano, Tokyo (JP); Masumi Kuga, Chiba (JP); Toshio Ogura, Chiba (JP)

(21) Appl. No.: 13/138,328

(22) PCT Filed: Jan. 28, 2010
(86) PCT No.: PCT/JP2010/051108

§ 371 Date: Sep. 2, 2011

(30) Foreign Application Priority Data
Feb. 9, 2009 (JP) 2009-027846
Feb. 9, 2009 (JP) 2009-027847

(51) Int. Cl. H05B 6/70

(52) U.S. Cl. 219/690

(57) ABSTRACT

PROBLEM TO BE SOLVED: To provide a microwave heating device evenly and efficiently irradiating a heating object with microwaves without using a turning mechanism.

SOLUTION: In an applicator 8, a heating object 12 such as a food is placed on an upper surface of a metal table 11 in a minimum capacity. A conically cut fluororesin spacer 13 is disposed above the heating object 12. A microwave synthesized in a T-shaped waveguide 7 is radiated to the heating object 12 through the conically cut fluororesin spacer 13. Thus, the synthesized microwave transmitted from the T-shaped waveguide 7 and having electric field difference of 90 degrees is refracted by a wavelength shortening action of the fluororesin spacer 13, and is evenly radiated to an area of the heating object 12 in a concentrated manner. Accordingly, the heating object 12 can be evenly and efficiently heated without providing a turntable.

### TECHNICAL FIELD

The present invention relates to a microwave heating device which radiates microwave power to a heating object. Especially, the present invention relates to a microwave heating device that performs thermal processing, sterilization, and the like of an individually-eaten food which is stored in a food packet or the like.

### BACKGROUND ART

Conventionally, a microwave oven and the like have been widely known as an applicator which heats a heating object such as a food by using microwave power. Reheating an individually-eaten food which is stored in a food packet by using such microwave oven is widely performed as well. In this case, a shape of the inside of the microwave oven which serves as a microwave irradiation chamber is cubic, and commonly, the capacity of the inside of the microwave oven is considerably larger than that of the individually-eaten food. Therefore, the individually-eaten food which is an irradiating object is not evenly irradiated with microwaves. Thus, a problem of so-called heating unevenness occurs. Accordingly, in microwave ovens, evenness of radiation of microwaves is achieved by a stirrer (metal rotary vane) for scattering microwaves, a turntable on which a tray (pan: table) turns, and the like.

Further, since the inside of the microwave oven is large, microwave loss on a wall surface of the inside is increased, resulting in degradation of heating efficiency (a ratio of microwave power which is absorbed by a food with respect to microwave power which is supplied to the inside of the microwave oven). Accordingly, it is designed such that the inside of the microwave oven is evenly irradiated by using a plurality of microwave generators, for example, so as to reduce heating unevenness of a heating object and improve the heating efficiency.

A technique by which microwaves are concentrated on the vicinity of a heating object by using a rectangular waveguide and a circular waveguide so as to enhance the heating efficiency is disclosed (refer to patent literature 1, for example). According to this technique, a magnetron is attached to the rectangular waveguide and microwave power is concentrated on a heating object which is stored in the circular waveguide by microwave power transmitted from the rectangular waveguide to the circular waveguide, being able to efficiently heating the heating object.

### PRIOR ART LITERATURE

### Patent Literature

Patent literature 1: Japanese Patent Application Laid Open No. 63-299084

### SUMMARY OF THE INVENTION

### Problems To Be Solved By the Invention

However, in a case of performing thermal processing or sterilization of individually-eaten foods for industrial use, such demand for a microwave heating device specialized for individually-eaten foods has been increased that microwave power should be evenly radiated by necessity and the heating object can be irradiated with the heating efficiency improved to the utmost extent. Further, from an aspect of credibility of a microwave heating device, a microwave heating device which does not need a stirrer and a turning mechanism such as a turntable in an applicator which is a microwave irradiation chamber has been demanded. In the technique disclosed in patent literature 1, the heating efficiency can be enhanced without a stirrer and a turning mechanism such as a turntable. However, in a case where a heating object does not have a shape similar to the circular waveguide, microwaves may not be able to be concentrated on the heating object. In such case, the heating efficiency cannot be enhanced. Microwave heating devices (microwave oven) for household use or for professional use also have the same problem.

The present invention is achieved in view of such problem. An object of the present invention is to provide a microwave heating device that can evenly and efficiently irradiate a heating object with microwaves without a turning mechanism and increase microwave power to be radiated.

### Means To Solve the Problems

To achieve the above object, a microwave heating device according to the present invention includes a waveguide configured to transmit microwave power, and an applicator that includes a dielectric board having a shape by which microwave transmitted from the waveguide is evenly dispersed to a heating object and having relative permittivity larger than 1, and irradiates the heating object with the microwave power radiated from the waveguide, through the dielectric board. Further, the microwave heating device employs a T-shaped waveguide, which is connected such that electric field directions intersect with each other, so as to increase the microwave power to be radiated.

### Effects of the Invention

According to the present invention, a heating object can be evenly irradiated with microwaves by optimizing the shape of a dielectric board (for example, a board made of fluororesin such as polytetrafluoroethylene) having a relative permittivity which is larger than 1 and small dielectric loss, and thus refracting the microwaves under favor of a wavelength shortening effect generated when the microwaves travel through the fluororesin board. As a result, even if a stirrer for scattering microwaves and a turntable for turning a heating object are not provided in the inside of an applicator (microwave irradiation chamber), the heating object can be effectively and evenly irradiated with the microwaves.

A T-shaped waveguide employed in the present invention does not cause mutual microwave interference even when two pieces of magnetrons are simultaneously operated, and can supply a sum of microwave power from the respective magnetrons to the applicator. Therefore, a high output of the microwave power can be stably supplied to a narrow and small space in which the number of ports for microwave irradiation to the applicator is limited, and the number of waveguides can be reduced in accordance with the number of magnetrons.

### BRIEF DESCRIPTION OF THE DRAWINGS

FIG. 1 is a configuration diagram showing a microwave heating device according to an embodiment of the present invention employing a T-shaped waveguide performing microwave synthesis.

FIG. 2 is a configuration sectional view showing an applicator according to the embodiment of the present invention.

FIG. 3 is a perspective view showing an opening of a launcher on a part connected with a WRJ-2 waveguide of a power monitor waveguide shown in FIG. 1.

FIG. 4a is a lateral view showing a section of a T-shaped microwave synthesizing waveguide 6 shown in FIG. 1. Dimensions are shown.

FIG. 4b shows a C face in FIG. 4a. Dimensions are shown.

FIG. 4c shows a B face in FIG. 4a. Dimensions are shown.

FIG. 5 shows an electric field direction of the C face in the T-shaped microwave synthesizing waveguide 6 in FIG. 4.

FIG. 6a is a temperature distribution diagram obtained by measuring an advantageous effect of the microwave heating device of the embodiment of the present invention while comparing with a comparison example, and showing a measurement result of the comparison example.

FIG. 6b is a temperature distribution diagram obtained by measuring an advantageous effect of the microwave heating device of the embodiment of the present invention while comparing with the comparison example, and showing a measurement result of the embodiment of the present invention.

### DETAILED DESCRIPTION OF THE EMBODIMENTS

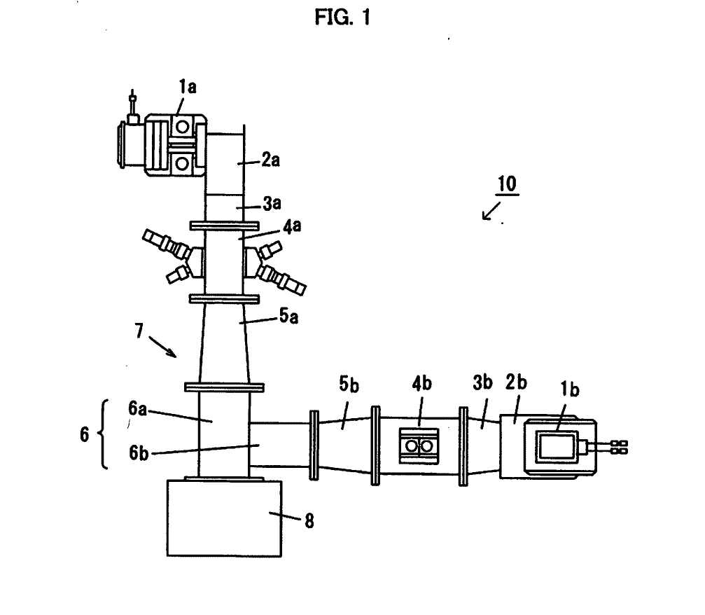

FIG. 1 is a configuration diagram showing a microwave heating device according to an embodiment of the present invention which employs a T-shaped waveguide which synthesizes microwaves. As shown in FIG. 1, a microwave heating device 10 includes magnetrons 1a and 1b, launchers (magnetron couplers) 2a and 2b for magnetrons, taper parts 3a and 3b, power monitor waveguides 4a and 4b, taper waveguides 5a and 5b, a T-shaped microwave synthesizing waveguide 6 which is composed of a main waveguide 6a and a sub waveguide 6b, and an applicator 8 which is a heating container. Here, the magnetron 1a is a first magnetron and the magnetron 1b is a second magnetron. Both of them generate microwaves having a frequency of 2.45 GHz.

A main waveguide is composed of the launcher 2a which is connected with the magnetron 1a (the first magnetron), the taper part 3a, the power monitor waveguide 4a, the taper waveguide 5a, and the main waveguide 6a. A sub waveguide is composed of the launcher 2b which is connected with the magnetron 1b (the second magnetron), the taper part 3b, the power monitor waveguide 4b, the taper waveguide 5b, and the sub waveguide 6b.

The magnetrons 1a and 1b which are a type of a diode vacuum tube are respectively attached to the launchers 2a and 2b of which the width of an opening is 95.3 mm and the height of the opening is 54.6 mm. Here, the width of the opening is a length in an X-axis direction orthogonal to a traveling direction of microwaves generated by the magnetrons 1a and 1b, and the height of the opening is a length in a Y-axis direction orthogonal to the traveling direction of the microwaves.

The launchers 2a and 2b have the taper part integrated configuration including the taper parts 3a and 3b for connecting to a 2.45 GHz standard waveguide: WRJ-2 (width dimension 109.2 mm, height dimension 54.6 mm). Accordingly, the launchers 2a and 2b are respectively connected to one ends of the power monitor waveguides 4a and 4b which are composed of WRJ-2 waveguides, through the taper parts 3a and 3b. Further, the power monitor waveguides 4a and 4b are devices that measure traveling wave power and reflected wave power which pass inside the WRJ-2 waveguides that are provided in the inside of the power monitor waveguides 4a and 4b. Here, the traveling wave power is microwave power transmitted from the magnetrons 1a and 1b to the applicator 8, while the reflected wave power is microwave power reflected by the applicator 8 and the like and transmitted to the magnetrons 1a and 1b.

The other ends of the power monitor waveguides 4a and 4b are respectively connected with one ends of the taper waveguides 5a and 5b, and the other ends of the taper waveguides 5a and 5b are connected with the T-shaped microwave synthesizing waveguide 6 which is composed of the main waveguide 6a and the sub waveguide 6b. A heating object (not shown) inside the applicator 8 is irradiated with microwave power of the magnetrons 1a and 1b which is synthesized by the T-shaped microwave synthesizing waveguide 6.

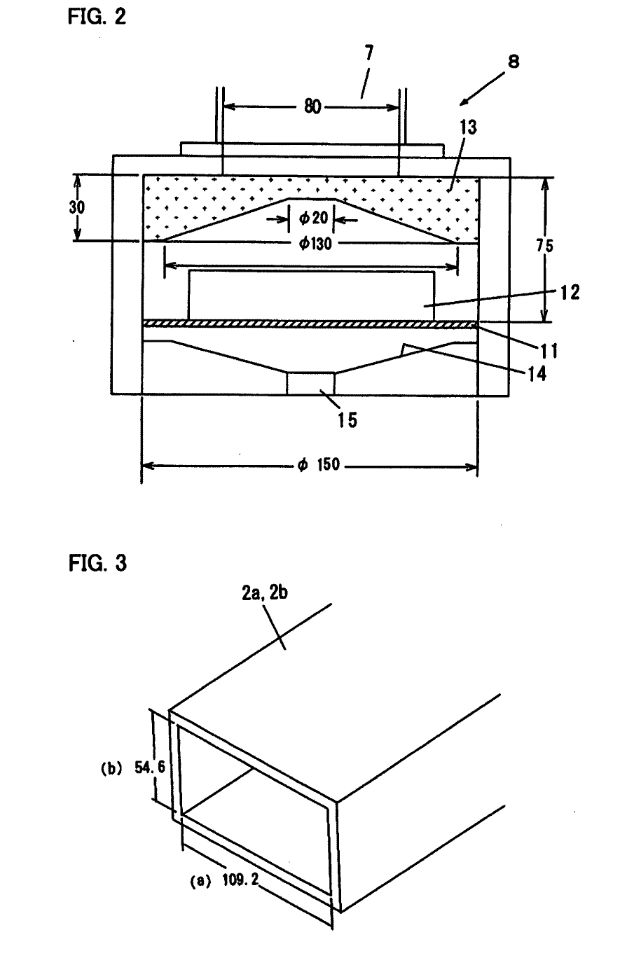

Thus, both microwave electric fields having a 90-degree-directional difference (that is, an electric field direction 10a of a main microwave and an electric field direction 10b of a sub microwave) are supplied from a C face side of the main waveguide 6a to the inside of the applicator (microwave irradiation chamber) 8 shown in FIGS. 1 and 2. Accordingly, power supplied to the applicator 8 is a sum of the microwave power transmitted through the main waveguide 6a and the microwave power transmitted through the sub waveguide 6b. Thus, high-output microwave power obtained by synthesizing two kinds of microwave power can be supplied to the applicator 8.

FIG. 2 is a configuration sectional view showing the applicator 8 according to the present invention. As shown in FIG. 2, the applicator 8 has a cylindrical shape. The applicator 8 is configured to have a minimum capacity so as to maximize the heating efficiency. The inner diameter of the capacity is Φ150 mm and the height is 75 mm. In such capacity, a heating object 12 such as a food is placed on an upper surface of a metal table 11.

Above the heating object 12, a conically-cut fluororesin spacer 13 is disposed. The fluororesin spacer 13 has the outer diameter of Φ150 mm and the thickness of 30 mm. On a surface, opposed to the heating object 12, of the fluororesin spacer 13, a cutout having a conic shape is formed. The shape of the cutout is the conic shape of which the diameter of a bottom surface is Φ130 mm, the height from the bottom surface to a top surface is 20 mm, and the diameter of a top part is Φ20 mm. Microwave power synthesized by the T-shaped waveguide 7 is radiated to the heating object 12 through the conically-cut fluororesin spacer 13.

That is, the T-shaped waveguide 7 is positioned on an upper surface side of the applicator 8 having the cylindrical shape and immediately below that, the fluororesin spacer 13 having the cutout of the conic shape is attached to an inner surface of the applicator 8 having the cylindrical shape.

Accordingly, the synthesized microwave power transmitted from the T-shaped waveguide 7 and having the electric field direction difference of 90 degrees is radiated to a food which is the heating object 12, through the fluororesin spacer 13. The relative permittivity ε of fluororesin is commonly about 2 (2.45 GHz/hour) and microwave loss (tan δ) is small, so that fluororesin is commonly used as a microwave transmission material so as to serve as a partition board or the like. That is, fluororesin is used as a thin partition board so as to prevent water vapor or oil vapor generated from the heating object 12 from flowing into the waveguide.

The velocity of the microwave traveling through fluororesin becomes as 1/√ε times large as that in vacuum, and the wavelength also becomes as 1/√ε times large as the wavelength λo in vacuum. That is, the wavelength of the microwave is shortened while the microwave travels through the fluororesin spacer 13. Therefore, by optimizing the shape of the fluororesin spacer 13 by forming a conic cutout, the microwave can be refracted so as to be dispersed and evenly radiated to the whole of the heating object 12. Thus, the heating object 12 can be efficiently irradiated with the microwave.

Describing more detail, the fluororesin spacer 13 having the conic shaped cutout has a refraction function similar to that of a concave lens of an optical system. Therefore, the synthesized microwave which is introduced from the T-shaped waveguide 7 to the inside of the applicator 8 is refracted by the fluororesin spacer 13 and dispersed to the whole of the heating object 12. Further, the fluororesin spacer 13 is close to the heating object 12, so that the synthesized microwave in a dispersed state can be radiated to an area of the heating object 12 in a concentrated manner. Accordingly, even if the capacity of the applicator 8 is large compared to the heating object 12, the microwave can be concentrated on the heating object 12 and be evenly radiated to the heating object 12 by optimizing the shape of the fluororesin spacer 13 in accordance with the shape of the heating object 12. Thus, the heating object 12 can be efficiently heated.

Below the metal table 11 which is made of a metallic plate or perforated metal, a drain pan 14 for catching drain and a drain pit 15 for discharging drain are provided. If a table made of a microwave transmissive material is provided instead of the metal table 11 and the drain pan 14 is made of a metallic material, microwaves radiated from the above can be reflected by the drain pan 14 so as to be radiated to the heating object 12. Accordingly, the heating object 12 can be further efficiently heated.

As described above, according to the microwave heating device of the present invention, microwaves can be evenly radiated to the heating object 12 by optimizing the shape of a board made of fluororesin such as polytetrafluoroethylene and using such phenomenon that microwaves are refracted when traveling through the fluororesin board. That is, even if a stirrer for scattering microwaves or a turntable for turning a heating object are not provided in the inside of the applicator 8, the microwaves can be evenly radiated to the heating object 12. Supplementary to the above, microwaves can be selectively radiated to the heating object 12 and the heating object 12 to which the microwaves are selectively radiated can be evenly heated.

Primary points of the T-shaped waveguide are specifically described.

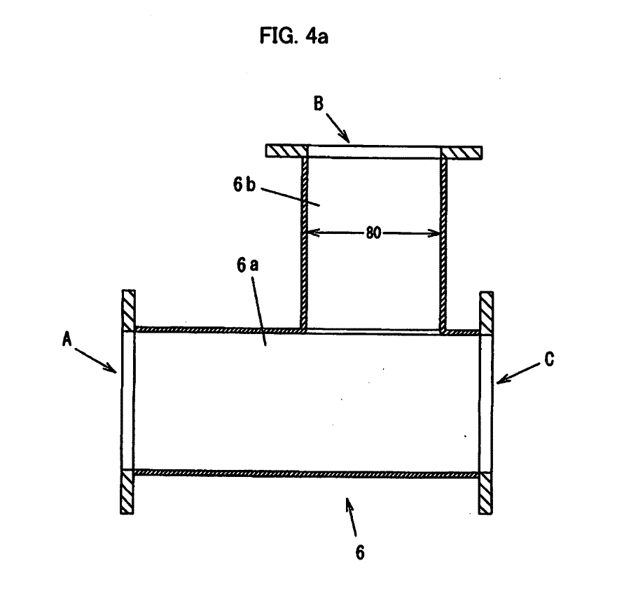

FIG. 3 is a perspective view showing an opening of the launchers 2a and 2b on parts which are connected with the WRJ-2 waveguides of the power monitor waveguides 4a and 4b shown in FIG. 1. Specifically, an opening on parts on which the taper parts 3a and 3b of the launchers 2a and 2b having the taper integrated configuration are connected with the power monitor waveguides 4a and 4b is shown. As shown in FIG. 3, as dimensions of the opening on the parts at which the launchers 2a and 2b are connected with the power monitor waveguides 4a and 4b, the width dimension a is a=109.2 mm, and the height dimension b is b=54.6 mm.

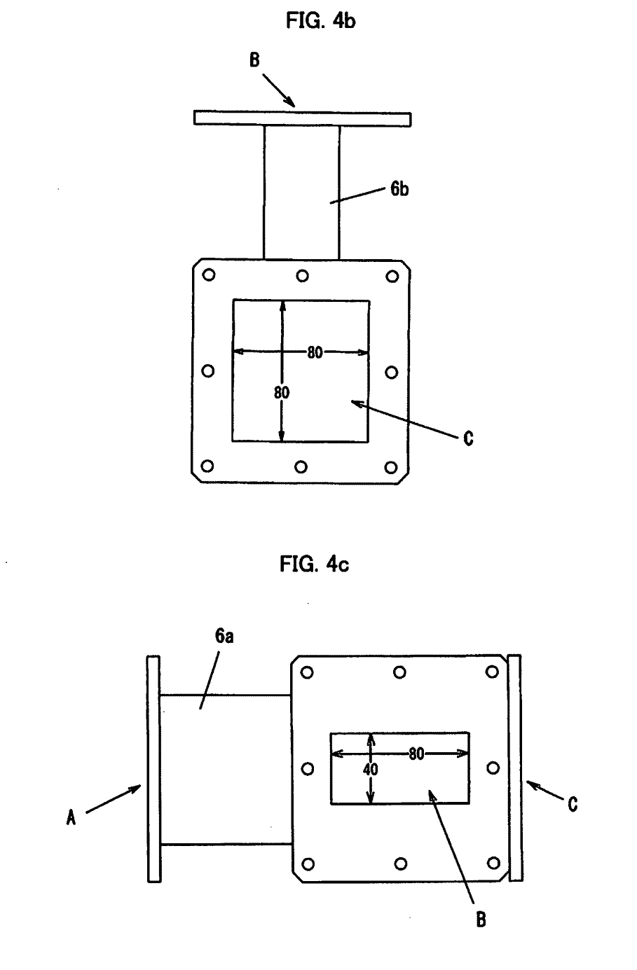

FIGS. 4a to 4c illustrate detailed dimensions of the T-shaped microwave synthesizing waveguide 6 shown in FIG. 1. FIG. 4a is a sectional view of the T-shaped microwave synthesizing waveguide 6, FIG. 4b shows a C face of FIG. 4a, and FIG. 4c shows a B face of FIG. 4a. As shown in FIG. 4a, this T-shaped microwave synthesizing waveguide 6 is configured such that the main waveguide 6a and the sub waveguide 6b are orthogonal to each other.

The dimension of the opening (A face) of the main waveguide 6a to which microwave power from the magnetron 1a (the first magnetron) is transmitted is 80 mm×80 mm (80 mm square) as is the case with the C face shown in FIG. 4b. That is, the microwave power from the magnetron 1a is transmitted to the opening of 80 mm square on the A face side which is one end of the main waveguide 6a of the T-shaped microwave synthesizing waveguide 6, through the launcher 2a, the power monitor waveguide 4a, and the taper waveguide 5a.

The microwave power from the other magnetron 1b (the second magnetron) is transmitted to the sub waveguide 6b constituting the T-shaped microwave synthesizing waveguide 6. The sub waveguide 6b is disposed orthogonal to the lateral surface of the main waveguide. The dimension of an opening (B face) connected with the main waveguide 6a is 80 mm×40 mm as shown in FIG. 4c. That is, the dimension in the X-axis direction (width a) orthogonal to the traveling direction (tube axis direction) of the microwave generated by the magnetron 1b is 80 mm, and the dimension in the Y-axis direction (height b) orthogonal to the traveling direction (tube axis direction) of the microwave generated by the magnetron 1b is 40 mm.

Here, the inner section surface orthogonal to the tube axis direction (Z-axis direction) of the rectangular wave guide is a rectangle. For the sake of the description, the dimension of one side of the rectangle is referred to as the width a and the dimension of another side orthogonal to the one side is referred to as the height b. That is, the width (a) and the height (b) have no relation on an actual installing direction of the waveguide.

In a case of such dimensional configuration (namely, the dimension of the opening (A face) of the main waveguide 6a of the T-shaped microwave synthesizing waveguide 6 is 80 mm×80 mm, and the dimension of the opening (B face) of the sub waveguide 6b is 80 mm×40 mm), the direction of an electric field formed by the microwave power which is transmitted to the main waveguide 6a by oscillation of the magnetron 1a and the direction of an electric field formed by the microwave power which is transmitted to the sub waveguide 6b by oscillation of the magnetron 1b are orthogonal to each other.

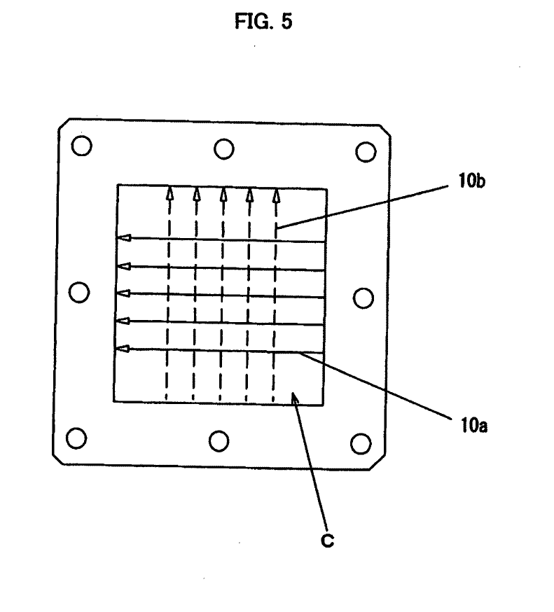

FIG. 5 illustrates an electric field direction on the C face of the T-shaped microwave synthesizing waveguide 6 of FIG. 4. That is, FIG. 5 shows an electric field direction of microwaves transmitted from the magnetron 1a through the main waveguide 6a (referred to below as an electric field direction 10a of a main microwave) and an electric field direction of microwaves transmitted from the magnetron 1b through the sub waveguide 6b (referred to below as an electric field direction 10b of a sub microwave) when viewed from the C face side (that is, a surface side from which the applicator 8 of FIG. 1 is irradiated) of the main waveguide 6a. As shown in FIG. 5, the electric field direction 10a of a main microwave and the electric field direction 10b of a sub microwave intersect with each other with directional difference of 90 degrees.

Thus, both microwave electric fields having the directional difference of 90 degrees are supplied to the applicator (microwave irradiation chamber) 8 of FIG. 1 from the C face side of the main waveguide 6a. The supplied power is a sum of the microwave power of the magnetron 1a and the microwave power of the magnetron 1b. Accordingly, the heating object in the applicator 8 can be irradiated with highly-outputted microwave power which is obtained by synthesizing the microwave power of the magnetron 1a and the microwave power of the magnetron 1b.

At this time, in the T-shaped microwave synthesizing waveguide 6, the microwave power of the magnetron 1a and the microwave power of the magnetron 1b are synthesized with each other, and further, the microwave power of the magnetron 1a and the microwave power of the magnetron 1b do not cause microwave interference mutually. The reason why the microwave power of the magnetron 1a and the microwave power of the magnetron 1b do not cause the microwave interference is that the directions of the electric fields formed by the mutual magnetrons 1a and 1b form the directional difference of 90 degrees and that the dimension of a part of the waveguide is limited so as to prevent microwaves from the other magnetron of which the electric field direction has the directional difference of 90 degrees from being transmitted. The reason why the microwave interference is not caused mutually will be described below in detail.

The in-tube wavelength λg of the microwave transmitted in the main waveguide 6a can be expressed as the following formula (1).

λg=λ/[1−(λ/2a)²]1/2 (1)

Here, λ denotes a free space wavelength of a radio wave (light speed/frequency of a microwave) (m). In a case where the frequency of a microwave is 2.45 GHz, λ=300,000 km/2.45 GHz=12.2 cm is expressed. Namely, the free space wavelength λ is 12.2 cm. Further, the width (a) is a width dimension of the main waveguide 6a and the sub waveguide 6b (the vertical surface width dimension with respect to the microwave electric field direction). From FIGS. 3 and 4, the vertical surface width dimension with respect to electric field components of two directions orthogonal to each other is 8 cm for each component. That is, the width (a) is 8 cm.

Accordingly, when λ=12.2 cm and a=8 cm are assigned to the formula (1), the in-tube wavelength λg becomes 18.9 cm. That is, in the waveguide of a=b=8 cm, the free space wavelength 12.2 cm in 2.45 GHz is increased to be a wavelength of 18.9 cm, and microwaves having the electric field components of two directions orthogonal to each other can be transmitted as they are.

On the other hand, as shown in FIG. 3, the height dimension of the launcher 2a to which the magnetron 1a is connected and the height dimension of the power monitor waveguide 4a are (b)=5.46 cm. The blocking wavelength of the microwave electric field generated between height b faces becomes λc=10.9 cm, being shorter than the free space wavelength 12.2 cm in 2.45 GHz. Therefore, the microwave electric field between the height b faces cannot be transmitted through the launcher 2a. That is, the microwave electric field transmitted from the magnetron 1b is transmitted to the main waveguide but is not transmitted to the power monitor waveguide 4a and the launcher 2a of which the height dimension is (b)=5.46 cm. Accordingly, the microwave from the magnetron 1b is synthesized with the microwave from the magnetron 1a on the C face of the T-shaped microwave synthesizing waveguide 6 and thus the electric field intensity can be set to be high output, but the microwave from the magnetron 1b does not cause the microwave interference with respect to the magnetron 1a.

Whether the microwave from the magnetron 1a is transmitted to the sub waveguide 6b side and causes the microwave interference or not will be next discussed. The direction of the microwave electric field formed by the magnetron 1a is parallel to the microwave traveling direction of the sub waveguide 6b and the microwave is not transmitted to the sub waveguide 6b. That is, a microwave electric field is not formed with respect to the microwave traveling direction, so that the microwave from the magnetron 1a is not transmitted to the magnetron 1b and does not cause the microwave interference.

As described above, in the microwave heating device of the related art, two pieces of magnetrons are operated alternately so as not to incur the microwave interference each other, so that the microwave power which can be supplied to the applicator has not be able to be increased. However, according to the microwave heating device 10 of the embodiment of the present invention, even though the two pieces of magnetrons 1a and 1b are simultaneously operated, high output of the microwave power can be supplied to the applicator 8 without causing the mutual microwave interference.

An attempt to synthesize microwave power of a plurality of magnetrons to generate high output is shown in Japanese Patent No. 2525506, Japanese Patent Application Laid Open No. 61-181093, and Japanese Patent No. 3888124.

In the invention described in Japanese Patent No. 2525506, an angle formed by axes of two pieces of waveguides which are microwave irradiation ports is set to be sharp angle intersection θ so as to prevent microwave interference. In this case, such microwave heating device is configured that includes a relatively-large applicator and the two pieces of waveguides which are provided to have the sharp angle intersection θ due to the enough space, and supplies microwaves from these two pieces of waveguides. However, in a case where a heating object is small, there is not a sufficient space. Therefore, a plurality of waveguides for microwave power supply cannot be attached by a predetermined angle due to insufficient space.

In the invention described in Japanese Patent Application Laid Open No. 61-181093, such a technique is disclosed that microwaves are evenly radiated to a heating object in an applicator (in a microwave oven) from respective microwave supply waveguides while performing duty control so as to prevent the two pieces of magnetrons from being simultaneously operated. According to this technique, the two pieces of magnetrons are not simultaneously operated, so that the above-mentioned microwave interference can be prevented.

Further, in the invention described in Japanese Patent No. 3888124, such technique is disclosed that microwave power generated from a plurality of magnetrons are synthesized by one waveguide and the synthesized microwave power is supplied to an applicator. According to this technique, two pieces of magnetrons are attached to one surface side of one waveguide so as to supply high output of microwave power to a narrow and small space including an electrodeless lamp which is a load. In this case as well, in order to prevent mutual microwave interference of the two pieces of magnetrons, supply of driving power sources is alternately switched to operate the two pieces of magnetrons alternately, and substantially, the two pieces of magnetrons are duty-controlled.

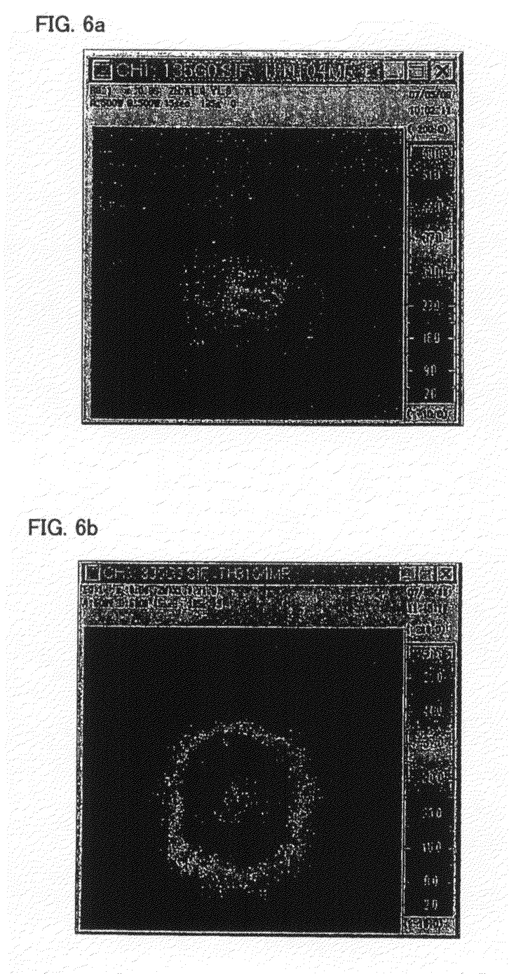

FIGS. 6a and 6b are temperature distribution diagrams obtained by measuring an advantageous effect of the microwave heating device of the embodiment of the present invention while comparing with a comparison example. FIG. 6a shows a measurement result of the comparison example, and FIG. 6b shows a measurement result of the embodiment. That is, these diagrams are obtained by measuring temperature distribution in a case where a food stored in a round-shape bag is heated by microwaves depending on presence/absence of the conically cut fluororesin spacer 13, by an infrared thermometer. FIG. 6a shows temperature distribution in a case where the fluororesin spacer 13 is not provided and FIG. 6b shows temperature distribution in a case where the fluororesin spacer 13 is provided.

Apparent from FIG. 6a and FIG. 6b, it is understood that the heating object 12 is more evenly irradiated with microwaves and the heating temperature is higher in the case where the fluororesin spacer 13 is provided (FIG. 6b). That is, by using the microwave heating device according to the invention, heating efficiency of the heating object 12 is enhanced and microwaves can be evenly radiated to the heating object 12.

Namely, if a spacer which has relative permittivity larger than 1 and smaller dielectric loss (tan δ) and includes a cutout optimized to a dielectric substance is used, an advantageous effect same as that of the above-described embodiment can be obtained. If microwaves are evenly radiated to the heating object 12 as this, a metal rotary vane (stirrer) for scattering microwaves and a turntable for turning a heating object are not needed. Thus, a turning mechanism is not needed, being able to further enhance credibility of the microwave heating device.

The present invention is specifically described based on the embodiment above. However, the present invention is not limited to the embodiment described above and various alterations can occur within the scope of the invention. For example, the heating object 12 can be evenly irradiated with microwaves by interposing a conically-cut silicone resin spacer, instead of the spacer made of polytetrafluoroethylene or the like (fluororesin).

Here, in a case of a food of which an outer circumferential shape is a ring shape or a central part is concaved in a state that it is placed on a tray, preferable heating (shortening in time required for heating) can be performed when microwaves are radiated to the circumference than when microwaves are radiated to the central part in a concentrated manner. In such case, the shape of the spacer is arbitrarily revised so that more microwaves are radiated to the circumference than the center of the heating object 12.

On the other hand, in a case of a food of which the central part is protruded, the central part is slowly heated. In such case, the shape of the spacer is arbitrarily revised so that more microwaves are radiated to the central part of the heating object 12.

Further, by enabling the inside of the applicator 8 to be airtightly pressurized by using the spacer 13 or the like, loss in moisture from a food can be prevented and the heating object 12 can be evenly heated by steam filling in the inside of the applicator 8.

Further, if the spacer 13 is set to be replaceable, a heating property of the microwave heating device can be transformed only by replacing the spacer 13.

By such handling, heating corresponding to a shape of a food or an object can be achieved.

### INDUSTRIAL APPLICABILITY

According to the present invention, heating efficiency of a heating object is high and the heating object can be evenly irradiated, so that the invention can be efficiently applied to a microwave heating device which performs thermal processing and sterilization of an individually-eaten food.

### DESCRIPTION OF REFERENCE NUMERALS

1a magnetron (first magnetron)

1b magnetron (second magnetron)

2a, 2b launcher

3a, 3b taper part

4a, 4b power monitor waveguide (WRJ-2 waveguide)

5a, 5b taper waveguide

6 T-shaped microwave synthesizing waveguide

6a main waveguide

6b sub waveguide

7 T-shaped waveguide

8 applicator

10 microwave heating device

10a electric field direction of a main microwave

10b electric field direction of a sub microwave

11 metal table

12 heating object

13 dielectric board (fluororesin spacer)

14 drain pan

15 drain pit

1.-9. (canceled)

10. A microwave heating device comprising:
a waveguide configured to transmit microwave power; and
an applicator that includes a dielectric board having a shape by which a microwave transmitted from the waveguide is evenly dispersed to a heating object and having relative permittivity larger than 1, and irradiates the heating object with the microwave power radiated from the waveguide, through the dielectric board, wherein
the waveguide is a T-shaped waveguide in which a main waveguide that transmits first microwave power and a sub waveguide that transmits second microwave power are connected with each other in a manner that electric field directions generated by microwaves of the main waveguide and the sub waveguide are orthogonal to each other.

11. The microwave heating device according to claim 10, wherein the applicator has a cylindrical shape and the dielectric board is a fluororesin spacer having a circular plate shape.

12. The microwave heating device according to claim 11, wherein a conic shaped cutout is formed in the fluororesin spacer so as to evenly disperse the microwave power radiated from the waveguide to the heating object.

13. The microwave heating device according to claim 10, wherein the applicator has a cylindrical shape and the dielectric board is a silicone resin spacer having a circular plate shape.

14. The microwave heating device according to claim 13, wherein a conic shaped cutout is formed in the silicone resin spacer so as to evenly disperse the microwave power radiated from the waveguide to the heating object.

15. The microwave heating device according to claim 10, wherein a dimension of an opening of a launcher is determined so that a blocking wavelength that is determined based on the dimension of the opening of the launcher formed on the main waveguide is shorter than a free space wavelength of a microwave transmitted from the sub waveguide to the main waveguide.

16. The microwave heating device according to claim 10, wherein a dimension of an opening of the sub waveguide is determined so that a blocking wavelength that is determined based on the dimension of the opening of the sub waveguide is shorter than a free space wavelength of a microwave transmitted from the main waveguide to the sub waveguide.

17. The microwave heating device according to claim 15, wherein
each of a frequency of the microwave transmitted through the main waveguide and a frequency of the microwave transmitted through the sub waveguide is 2.45 GHz,
a dimension of an opening of the main waveguide is width 80 mm×height 80 mm, the dimension of the opening of the sub waveguide is width 80 mm×height 40 mm, and the dimension of the opening of the launcher is width 109.2 mm×height 54.6 mm.
